(19) United States
(12) Patent Application Publication
(10) Pub. No.: US 2021/0323384 A1
(43) Pub. Date: Oct. 21, 2021

(54) CONTROL DEVICE FOR VEHICLE SHARING SYSTEM

(71) Applicant: TOYOTA JIDOSHA KABUSHIKI KAISHA, Aichi-ken (JP)

(72) Inventor: Miyako SAKAI, Toyota-shi (JP)

(21) Appl. No.: 17/200,904

(22) Filed: Mar. 15, 2021

(30) Foreign Application Priority Data
Apr. 16, 2020 (JP) 2020-073300

(51) Int. Cl. B60H 3/00; B60H 1/00

(52) U.S. Cl. CPC B60H 3/0035; B60H 1/00985; B60H 3/0028

(57) ABSTRACT

Provided is a control device for a vehicle sharing system in which a plurality of persons shares a vehicle having a fragrance generator configured to generate a fragrance in a vehicle cabin, the device including an acquiring unit configured to acquire user preference information as information relating to a fragrance preferred by a user who starts using the vehicle, and a usage start date and time when the user starts using the vehicle, and a controller configured to cause the fragrance generator to generate the fragrance preferred by the user in the vehicle cabin based on the user preference information before the usage start date and time.

### CROSS-REFERENCE TO RELATED APPLICATION

This application claims priority to Japanese Patent Application No. 2020-073300 filed on Apr. 16, 2020, incorporated herein by reference in its entirety.

### BACKGROUND

### 1. Technical Field

The disclosure relates to a control device for a vehicle sharing system, in particularly, a control device for a vehicle sharing system in which a plurality of persons shares a vehicle having a fragrance generator configured to generate a fragrance in a vehicle cabin.

### 2. Description of Related Art

In the related art, a vehicle including a fragrance generator has been proposed (for example, see Japanese Unexamined Patent Application Publication No. 2002-362143 (JP 2002-362143 A)). The fragrance generator releases a plurality of fragrance substances in a plurality of seats in a vehicle cabin. In a case where the fragrance substances are released, the fragrance preferred by an occupant who seats in each seat is released to each seat. As a result, the fragrance that matches the preference of the occupant is released to the occupant.

### SUMMARY

Meanwhile, in the vehicle sharing system in which the persons shares the vehicle having the fragrance generator configured to generate the fragrance in the vehicle cabin, when a new user starts using the vehicle, the fragrance preferred by another user who uses the vehicle previously may remain in the vehicle cabin. In a case where the fragrance preferred by another user who uses the vehicle previously is different from the fragrance preferred by the new user, the new user may feel unpleasant with the fragrance remaining in the vehicle cabin, and may not be able to comfortably use the vehicle.

A control device for a vehicle sharing system according to an aspect of the disclosure is to allow the user to comfortably use the vehicle.

A control device for a vehicle sharing system according to the disclosure adopts following means.

An aspect of the disclosure relates to a control device for a vehicle sharing system in which a plurality of persons shares a vehicle having a fragrance generator configured to generate a fragrance in a vehicle cabin. The device includes an acquiring unit, and a controller. The acquiring unit is configured to acquire user preference information as information relating to a fragrance preferred by a user who starts using the vehicle, and a usage start date and time when the user starts using the vehicle. The controller is configured to cause the fragrance generator to generate the fragrance preferred by the user in the vehicle cabin based on the user preference information before the usage start date and time.

In the control device for a vehicle sharing system according to the aspect of the disclosure, the acquiring unit is configured to acquire user preference information as information relating to fragrance preferred by a user who starts using the vehicle, and a usage start date and time when the user starts using the vehicle. The controller is configured to cause the fragrance generator to generate the fragrance preferred by the user in the vehicle cabin based on the user preference information before the usage start date and time. Therefore, when the user starts using the vehicle, the vehicle cabin can be scented with the fragrance preferred by the user. As a result, the user can comfortably use the vehicle.

The control device for a vehicle sharing system according to the aspect of the disclosure may further include an input receiver configured to receive input of taste-related information relating to taste of the user, in which the acquiring unit is configured to acquire the user preference information by using the input taste-related information. Then, the fragrance preferred by the user based on the input taste-related information can be generated in the vehicle cabin. As a result, the user can more comfortably use the vehicle.

In this case, the taste-related information may be a category of the fragrance preferred by the user. Then, the fragrance preferred by the user based on the category of the fragrance preferred by the user can be generated in the vehicle cabin. As a result, the user can more comfortably use the vehicle.

In this case, the control device may further include a display unit configured to display a plurality of questions regarding the taste of the user, in which the input receiver is configured to receive input of answers of the user regarding the questions as the input of the taste-related information. Then, the fragrance preferred by the user based on the answers of the user regarding the questions can be generated in the vehicle cabin. As a result, the user can more comfortably use the vehicle.

In the control device for a vehicle sharing system according to the aspect of the disclosure, the vehicle may include an air conditioner that performs air conditioning, the user preference information may include the fragrance preferred by the user, and an intensity of the fragrance that the user feels comfortable, and the controller may be configured to control the fragrance generator and the air conditioner such that the fragrance preferred by the user is generated in the vehicle cabin, and an intensity of the fragrance in the vehicle cabin becomes the intensity of the fragrance that the user feels comfortable based on the user preference information before the usage start date and time. Then, the vehicle cabin can be scented with the fragrance preferred by the user, and the intensity of the fragrance can be made to the intensity that the user feels comfortable. As a result, the user can more comfortably use the vehicle.

In the control device for a vehicle sharing system according to the aspect of the disclosure, the vehicle sharing system may include the vehicle, and a management server configured to manage the vehicle, the acquiring unit may be mounted on the management server, and the controller may be mounted on the vehicle. Then, with the vehicle sharing system including the vehicle, and the management server, the user can comfortably use the vehicle.

In the control device for a vehicle sharing system according to the aspect of the disclosure, the control device further includes the input receiver configured to receive input of taste-related information relating to taste of the user, the vehicle sharing system may include the vehicle, a management server configured to manage the vehicle, and a terminal device used by the user, the input receiver may be mounted on the terminal device, the acquiring unit may be mounted on the management server, and the controller may be mounted on the vehicle. Then, with the vehicle sharing system including the vehicle, the management server, and the terminal device, the user can comfortably use the vehicle.

In the control device for a vehicle sharing system according to the aspect of the disclosure, the control device further includes a display unit configured to display a plurality of questions regarding the taste of the user, the vehicle sharing system may include the vehicle, a management server configured to manage the vehicle, and a terminal device used by the user, the input receiver and the display unit may be mounted on the terminal device, the acquiring unit may be mounted on the management server, and the controller may be mounted on the vehicle. Then, with the vehicle sharing system including the vehicle, the management server, and the terminal device, the user can comfortably use the vehicle.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a configuration diagram showing a schematic configuration of a car sharing system 10 as an embodiment of the disclosure;

FIG. 2 is a configuration diagram showing an example of a configuration of a fragrance generator 32;

FIG. 3 is a flowchart showing an example of a usage reservation processing routine executed by a portable terminal device 70;

FIG. 4 is an explanatory diagram showing an example of a fragrance category selection screen;

FIG. 5 is a flowchart showing an example of an information transmission processing routine executed by a computer 21 of a management center 20;

FIG. 6 is a flowchart showing an example of prior fragrance release processing routine executed by a vehicle ECU 50 of a vehicle 30; and

FIG. 7 is an explanatory diagram showing examples of a plurality of questions regarding taste of a user and options of answers regarding the questions.

### DETAILED DESCRIPTION OF EMBODIMENTS

Hereinafter, an embodiment for carrying out the disclosure will be described.

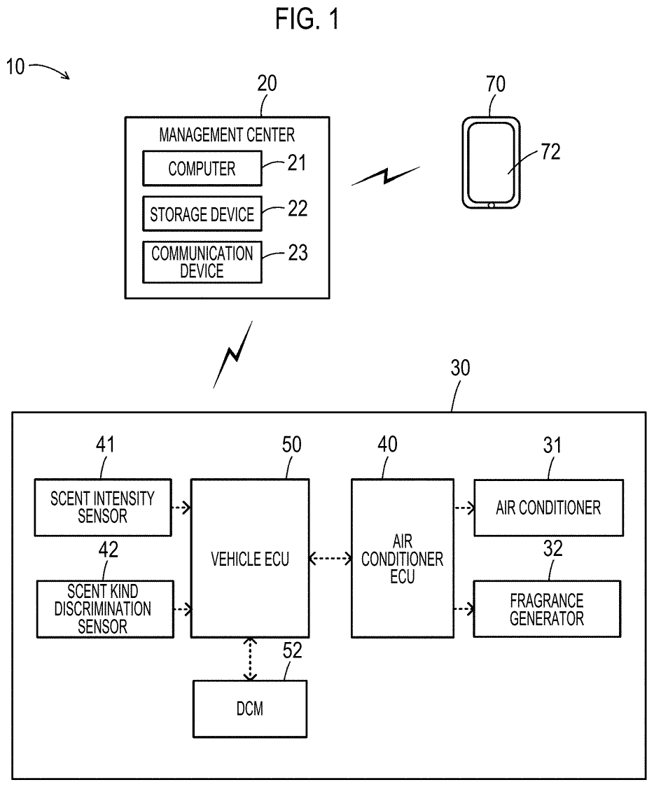

FIG. 1 is a configuration diagram showing a schematic configuration of a car sharing system 10 including a control device as an embodiment of the disclosure. The car sharing system 10 includes a management center 20, a vehicle 30, and a portable terminal device 70 as shown in FIG. 1.

The management center 20 includes a computer 21, a storage device 22, and a communication device 23. The computer 21 functions as a management server, and has a CPU, a ROM, a RAM, an input and output port, or a communication port. The storage device 22 is configured by a large-capacity storage medium, such as a hard disk or a SSD. The storage device 22 stores data related to each parked vehicle for each station where the vehicle is parked. The communication device 23 performs communication between the computer 21 and the outside (vehicle 30 or portable terminal device 70). The computer 21, the storage device 22, and the communication device 23 are connected to each other via a signal line.

The vehicle 30 includes, in addition to a power source for traveling (engine or motor) (not shown), an air conditioner 31, a fragrance generator 32, an electronic control unit for an air conditioner (hereinafter, referred to as “air conditioner ECU”) 40, and an electronic control unit for a vehicle (hereinafter, referred to as “vehicle ECU”) 50.

The air conditioner 31 is configured as a device that performs air conditioning in a vehicle cabin Cab, and, although not shown, includes a refrigeration cycle including a compressor, a condenser, an expansion valve, or an evaporator, and a blower for an air conditioner (blower motor for an air conditioner) that blows air cooled by heat exchange with the evaporator of the refrigeration cycle to an outlet in the vehicle cabin Cab. The compressor or the blower for an air conditioner is controlled by the air conditioner ECU 40.

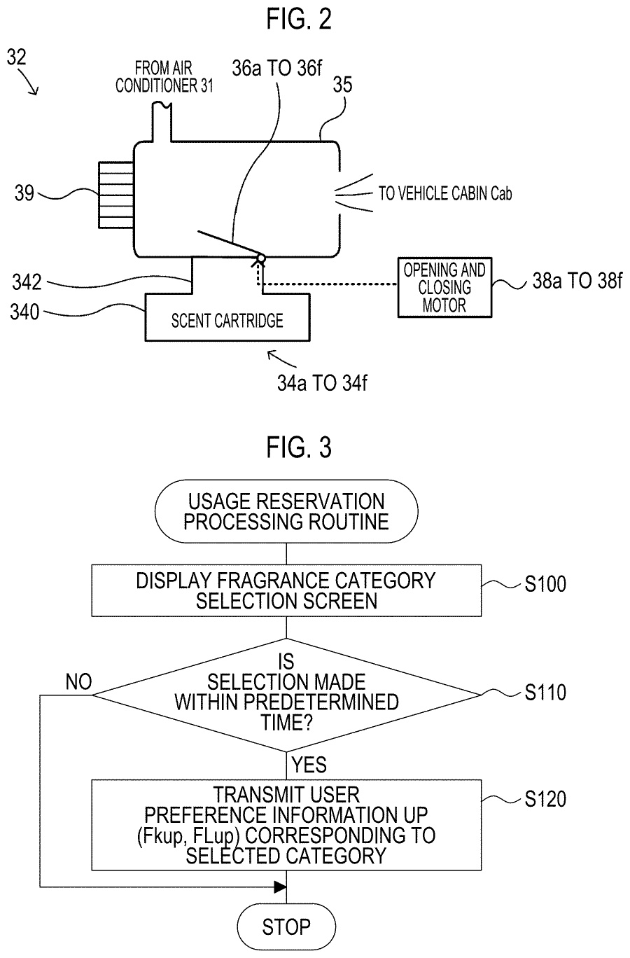

FIG. 2 is a configuration diagram showing an example of a configuration of the fragrance generator 32. The fragrance generator 32 is disposed near the air conditioner 31, and includes scent cartridges 34a to 34f, a connection unit 35, opening and closing doors 36a to 36f, opening and closing motors 38a to 38f, and a fragrance generating blower (fragrance generating blower motor) 39.

The scent cartridges 34a to 34f include a storage unit 340 that stores a solution including fragrance substances that generate fragrances Fr1 to Fr6 corresponding to six categories of fragrance described below or porous silica beads impregnated with such a solution, and an opening unit 342 of which an upper portion in FIG. 2 opens. The opening unit 342 is attachably and detachably fitted into an opening formed in the connection unit 35. The connection unit 35 connects the scent cartridges 34a to 34f with the vehicle cabin Cab. A part of cooled air is taken into the connection unit 35 from the air conditioner 31. The opening and closing doors 36a to 36f are attached to the opening unit 342 of the scent cartridges 34a to 34f. The opening and closing door 36a to 36f open and close the opening unit 342 of the scent cartridges 34a to 34f to perform the release of the fragrance substances from the storage unit 340 and blocking the release. The opening and closing doors 36a to 36f are driven by the opening and closing motors 38a to 38f. The fragrance generating blower 39 blows the fragrance substances volatilized from the scent cartridges 34a to 34f of the connection unit 35 to the outlet of the vehicle cabin Cab. The opening and closing motors 38a to 38f and the fragrance generating blower 39 are controlled by the air conditioner ECU 40. In the fragrance generator 32, in a case where one of the opening and closing doors 36a to 36f opens, the fragrance substances volatilized from the storage unit 340 corresponding to the opening and closing door that is opened (any one of the opening and closing doors 36a to 36f) are released to the connection unit 35 via the opening unit 342. The fragrance substances released in the connection unit 35 are released in the vehicle cabin Cab from an outlet of the air conditioner 31 by blowing of the fragrance generating blower 39. As a result, among the fragrances Fr1 to Fr6, the fragrance of the fragrance substances volatilized from the storage unit 340 corresponding to the opening and closing door that is opened (any one of the opening and closing doors 36a to 36f) is generated in the vehicle cabin Cab. In a case where all of the opening and closing doors 36a to 36f are closed, the release of the fragrance substances volatilized from the storage unit 340 into the connection unit 35 is blocked. As a result, the release of the fragrance substances into the vehicle cabin Cab from the outlet of the air conditioner 31 is stopped, and the fragrance is not generated in the vehicle cabin Cab.

Although not shown, the air conditioner ECU 40 is configured as a microprocessor centered on the CPU, and includes, in addition to the CPU, a ROM storing processing programs, a RAM storing data temporarily, an input and output port, and a communication port. A vehicle cabin temperature or the like from a temperature sensor (not shown) that detects a temperature of the vehicle cabin is input to the air conditioner ECU 40. Various control signals are output from the air conditioner ECU 40 via the output port. Examples of the signals output from the air conditioner ECU 40 include a drive signal to the compressor (not shown), a drive signal to the blower for an air conditioner (blower motor), a drive signal to the opening and closing motors 38a to 38f, or a drive signal to the fragrance generating blower 39. The air conditioner ECU 40 exchanges various data with the vehicle ECU 50 by communication.

Although not shown, the vehicle ECU 50 is configured as a microprocessor centered on the CPU, and includes, in addition to the CPU, a ROM storing processing programs or a vehicle identification number Vid of each vehicle, a RAM storing data temporarily, an input and output port, and a communication port. Signals from various sensors are input to the vehicle ECU 50. Examples of the signals input to the vehicle ECU 50 include a detection signal from a sensor that detects a state of the power source, a scent level FL in the vehicle cabin from a scent intensity sensor 41 that detects an intensity of the scent in the vehicle cabin Cab, or a kind of scent FK in the vehicle cabin from a scent kind discrimination sensor 42 that discriminates a kind of scent in the vehicle cabin Cab. The scent kind discrimination sensor 42 includes a plurality of scent intensity sensors that detect the intensity of different scents, and outputs the scent detected by the scent intensity sensor having the largest detection value among the scent intensity sensors as the kind of scent FK in the vehicle cabin. Examples of the signals input to the vehicle ECU 50 include ID card information from a card reader (not shown) that reads information of an ID card carried by the user in a non-contact manner. Various control signals are output from the vehicle ECU 50 via the output port. Examples of the signals output from the vehicle ECU 50 include control signals for controlling the power source for traveling. The vehicle ECU 50 executes various calculations for traveling the vehicle 30. The vehicle ECU 50 performs communication with the outside via a data communication module (hereinafter, referred to as “DCM”) 52.

The portable terminal device 70 is configured as a terminal device that can be carried by the user, and includes a main body (not shown), a display 72, and a communication device. Although not shown, the main body includes a CPU, a ROM, a RAM, a storage medium, an input and output port, and a communication port. The storage medium of the main body stores various applications. The display 72 is configured as a touch panel type display device, and receives the input of the user. The communication device performs communication between the main body and the outside. The portable terminal device 70 transmits executing instructions of various processing such as usage reservation of the vehicle 30 and settlement of a usage fee of the vehicle 30, or various information input by the user to the management center 20 via the communication device based on the operation of the display 72 by the user.

In the car sharing system 10 having such a configuration, various processing such as the usage reservation of the vehicle 30 that is parked at the station are executed based on the operation of the display 72 of the portable terminal device 70 by the user.

The usage reservation of the vehicle 30 is performed as follows. When the user operates the display 72 of the portable terminal device 70 to input reservation request information, the portable terminal device 70 transmits the reservation request information to the management center 20 via the communication device. The reservation request information includes, for example, an identification number of the user (user identification number) Pid, information on a credit card, an area of the station where the desired vehicle to be used is parked, a vehicle kind of the desired vehicle to be used, an usage start date and time ST, and a return date and time. The computer 21 of the management center 20 determines whether the vehicle matching the reservation request information received via the communication device 23 can be prepared, based on the data of the vehicle for each station stored in the storage device 22. In a case where the vehicle matching the reservation request information can be prepared, the computer 21 of the management center 20 transmits the reservation request information to the vehicle 30 that is a reservation target via the communication device 23 while storing the reservation request information in the storage device 22 as reservation information, and transmits a reservation completion notice to the portable terminal device 70. In a case where the vehicle matching the received reservation request information cannot be prepared, the computer 21 of the management center 20 transmits a reservation unacceptable notice to the portable terminal device 70 via the communication device 23. The vehicle ECU 50 of the vehicle 30 that receives the reservation information stores the reservation information in the RAM (not shown).

In the vehicle 30 reserved in this way, in a case where the information from the non-contact ID card carried by the user is read into the card reader (not shown) mounted on the vehicle 30, the vehicle ECU 50 of the vehicle 30 compares the user identification number Pid included in the reservation information stored in the RAM with the identification number of the ID card to perform user authentication. In a case where the user identification number Pid included in the reservation information and the identification number of the ID card match, and the user authentication is successful, the vehicle ECU 50 of the vehicle 30 transmits the vehicle identification number Vid, the user identification number Pid, and a usage start signal to the management center 20 via the DCM 52. The computer 21 of the management center 20 that receives the vehicle identification number Vid, the user identification number Pid, and the usage start signal via the communication device 23 transmits an unlock permission signal to the vehicle 30 corresponding to the vehicle identification number Vid via the communication device 23. The vehicle ECU 50 of the vehicle 30 that receives the unlock permission signal via the DCM 52 unlocks a door of the vehicle 30. The vehicle 30 of which the door is unlocked is operated in the same manner as a normal vehicle by the user who obtains a key stored in a storage box in the vehicle cabin Cab. In this way, the use of the vehicle 30 is started.

The usage of the vehicle 30 is stopped as follows. In a case where the user returns the key in the storage box in the vehicle cabin Cab, and the information from the non-contact ID card carried by the user is read into the card reader (not shown), the vehicle ECU 50 of the vehicle 30 compares the user identification number Pid included in the reservation information stored in the RAM with the identification number of the ID card to perform user authentication. In a case where the user identification number Pid included in the reservation information and the identification number of the ID card match and the user authentication is successful, the vehicle ECU 50 of the vehicle 30 transmits the vehicle identification number Vid, the user identification number Pid, and a usage stop signal to the management center 20 via the DCM 52. The computer 21 of the management center 20 that receives the usage stop signal via the communication device 23 transmits a lock permission signal to the vehicle 30 corresponding to the vehicle identification number Vid via the communication device 23, transmits an evaluation request signal to the portable terminal device 70, and executes predetermined settlement processing. The predetermined settlement processing is performed by settling the settlement amount based on the fee plan selected by the user when reserving, with the credit card included in the reservation information. The vehicle ECU 50 of the vehicle 30 that receives the lock permission signal via the DCM 52 locks the door.

Next, the operation of the car sharing system 10 of the embodiment configured in this way, in particular, the operation when the usage reservation of the vehicle 30 is made will be described. FIG. 3 is a flowchart showing an example of a usage reservation processing routine executed by the portable terminal device 70. The routine is executed by the CPU of the main body of the portable terminal device 70 after the user operates the display 72 of the portable terminal device 70 to input the reservation request information.

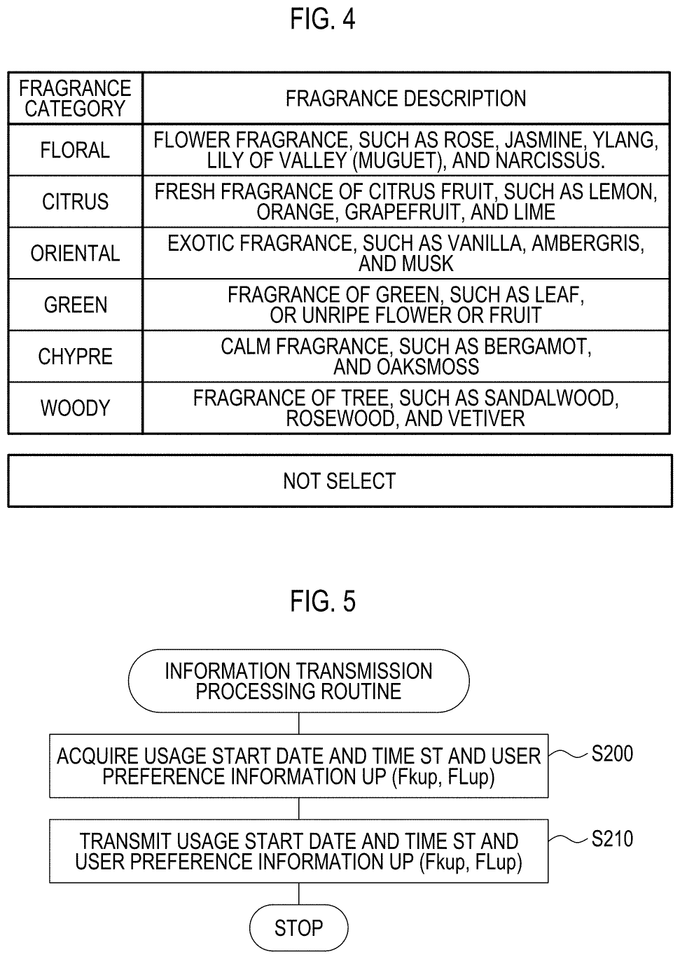

In a case where the usage reservation processing routine is executed, the CPU of the portable terminal device 70 executes processing of displaying a fragrance category selection screen on the display 72 (step S100). FIG. 4 is an explanatory diagram showing an example of the fragrance category selection screen. The fragrance category selection screen includes a “fragrance category” column, a “fragrance description” column, and a “not select” column. Here, the “fragrance category” refers to categories of fragrances Fr1 to Fr6 that can be generated from the scent cartridges 34a to 34f. Examples of the “fragrance category” include “floral”, “citrus”, “oriental”, “green”, “chypre”, and “woody”. The “fragrance description” refers to a sentence explaining what kind of fragrances the six fragrance categories are. Examples of the “fragrance description” include “fragrance of flower, such as rose, jasmine, ylang ylang, lily of the valley (muguet), and narcissus” as “floral”.

When the fragrance category selection screen is displayed on the display 72, determination is made as to whether one fragrance category is selected among six fragrance categories within a predetermined time twait after the fragrance category selection screen is displayed on the display 72 (step S110). The selection of the fragrance category is performed by selecting one fragrance category in the “fragrance category” column on the display 72 by the user's operation.

In step S110, in a case where one fragrance category is not selected among six fragrance categories within the predetermined time twait, that is, a case where the fragrance category is not selected within the predetermined time twait or a case where the “not select” column is selected, the usage reservation processing routine ends.

In step S110, in a case where one fragrance category is selected among six fragrance categories, user preference information UP including a fragrance FKup corresponding to the selected fragrance category (selected category) SFR and the intensity of the fragrance (fragrance level) FLup is transmitted to the management center 20 (step S120), and the usage reservation processing routine ends. The fragrance FKup is a fragrance corresponding to the selected category SFRsec among the fragrances Fr1 to Fr6 that can be released from the scent cartridges 34a to 34f. The fragrance level FLup is an intensity that is predetermined as the intensity of the fragrance that the user feels comfortable in a case where the fragrance released from the scent cartridges 34a to 34f into the vehicle cabin Cab is the fragrance FKup. By such processing, the user preference information UP that is information on the fragrance preferred by the user is transmitted to the management center 20 from the portable terminal device 70.

Subsequently, the operation of the management center 20 that receives the user preference information UP will be described. FIG. 5 is a flowchart showing an example of an information transmission processing routine executed by the computer 21 of the management center 20. The information transmission processing routine is executed when the user preference information UP from the portable terminal device 70 is received by the communication device 23 of the management center 20.

In a case where the information transmission processing routine is executed, the computer 21 of the management center 20 executes processing of acquiring the usage start date and time ST and the user preference information UP (step S200). The usage start date and time ST included in the reservation information stored in the storage device 22 when the usage of the vehicle 30 is reserved is acquired by communication. The user preference information UP received by the communication device 23 of the management center 20 is acquired by communication.

In a case where the usage start date and time ST and the user preference information UP are acquired, the acquired usage start date and time ST and user preference information UP are transmitted to the vehicle 30 via the communication device 23 (step S210), the information transmission processing routine ends. By such processing, the user preference information UP that is information on the fragrance preferred by the user and the usage start date and time ST of the vehicle 30 desired by the user can be transmitted to the vehicle 30 from the management center 20.

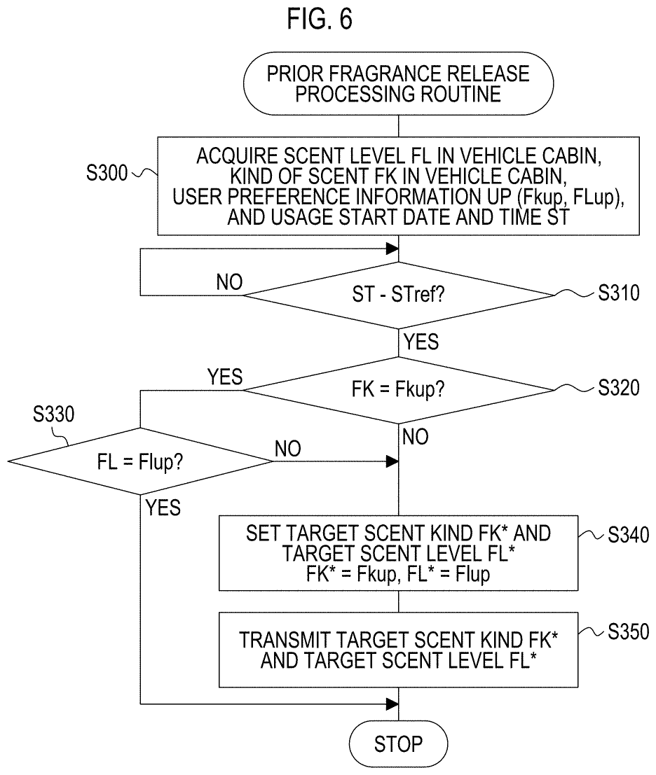

Subsequently, the operation of the vehicle 30 that receives the usage start date and time ST and the user preference information UP from the management center 20 will be described. FIG. 6 is a flowchart showing an example of prior fragrance release processing routine executed by the vehicle ECU 50 of the vehicle 30. The prior fragrance release processing routine is executed when the DCM 52 receives the usage start date and time ST and the user preference information UP from the management center 20.

In a case where the prior fragrance release processing routine is executed, the CPU (not shown) of the vehicle ECU 50 executes processing of acquiring the scent level FL in the vehicle cabin, the kind of scent FK in the vehicle cabin, the user preference information UP, and the usage start date and time ST (step S300). The scent level FL in the vehicle cabin detected by the scent intensity sensor 41 is acquired. The kind of scent FK in the vehicle cabin detected by the scent kind discrimination sensor 42 is acquired. The user preference information UP and the usage start date and time ST transmitted from the management center 20 are acquired via the communication device 23 and the DCM 52.

Subsequently, determination is made as to whether the time becomes a predetermined time STref before the usage start date and time ST (step S310). The predetermined time STref is a time that is predetermined, as a time needed to make the fragrance in the vehicle cabin Cab be the intensity that the user feels comfortable after starting the operation of the fragrance generator 32, by the experiment or the analysis using the volume of the vehicle cabin Cab and the performance of the fragrance generator 32, and is set to, for example, 3 minutes, 5 minutes, or 7 minutes. In step S310, when the time does not become the predetermined time STref before the usage start date and time ST, the processing waits until the predetermined time STref before the usage start date and time ST comes.

In step S310, when the time becomes the predetermined time STref before the usage start date and time ST, subsequently, determination is made as to whether the kind of scent FK in the vehicle cabin is the fragrance FKup selected by the user (step S320). In a case where the kind of scent FK in the vehicle cabin is the fragrance FKup selected by the user, determination is made that the fragrance in the vehicle cabin Cab is the fragrance preferred by the user, and subsequently, determination is made as to whether the scent level FL in the vehicle cabin is the fragrance level FLup (step S320). In a case where the scent level FL in the vehicle cabin is the fragrance level FLup, determination is made that the intensity of the fragrance in the vehicle cabin Cab is the intensity that the user feels comfortable, and the routine ends.

In a case where the kind of scent FK in the vehicle cabin is different from the fragrance FKup selected by the user in step S320, or in a case where the kind of scent FK in the vehicle cabin is the fragrance FKup selected by the user in step S320, but the scent level FL in the vehicle cabin is not the fragrance level FLup in step S330, the fragrance FKup selected by the user is set as a target scent kind FK* and the fragrance level FLup is set as a target scent level FL* (step S340), the target scent kind FK* and the target scent level FL* are transmitted to the air conditioner ECU 40 (step S350), and the routine ends. The air conditioner ECU 40 that receives the target scent kind FK* and the target scent level FL* controls the opening and closing motors 38a to 38f such that the opening and closing door of the cartridge (corresponding cartridge) corresponding to the target scent kind FK* among the opening and closing doors 36a to 36f is opened, other opening and closing doors are closed, and the fragrance substances stored in the corresponding cartridge are released, and controls the air conditioner 31 and the fragrance generating blower 39 of the fragrance generator 32 such that the scent level FL in the vehicle cabin is the target scent level FL*. By such control, the fragrance preferred by the user is generated in the vehicle cabin Cab before the user starts using the vehicle 30, and when the user starts using the vehicle 30, the vehicle cabin Cab can be scented with the fragrance preferred by the user, and the intensity of the fragrance in the vehicle cabin Cab can be the intensity that the user feels comfortable. As a result, when the user starts using the vehicle 30, the user can comfortably use the vehicle.

According to the car sharing system 10 including the control device of the embodiment, the computer 21 of the management center 20 acquires the user preference information UP and the usage start date and time ST, the air conditioner ECU 40 and the vehicle ECU 50 of the vehicle 30 cause the fragrance generator 32 to generate the fragrance preferred by the user in the vehicle cabin Cab based on the user preference information UP before the usage start date and time ST, and thus the user can comfortably use the vehicle.

Also, the portable terminal device 70 receives input of the selected category SFR, and the management center 20 acquires the user preference information UP based on the selected category SFR, and thus the vehicle cabin can be scented with the fragrance preferred by the user, and the user can comfortably use the vehicle.

Further, the user preference information UP includes the fragrance FKup preferred by the user and the fragrance level FLup that the user feels comfortable, the air conditioner ECU 40 and the vehicle ECU 50 of the vehicle 30 controls air conditioner 31 and the fragrance generator 32 such that the fragrance preferred by the user is generated in the vehicle cabin Cab based on the user preference information UP and the scent level FL in the vehicle cabin is the fragrance level FLup before the predetermined time STref from the usage start date and time ST, and thus the user can more comfortably use the vehicle.

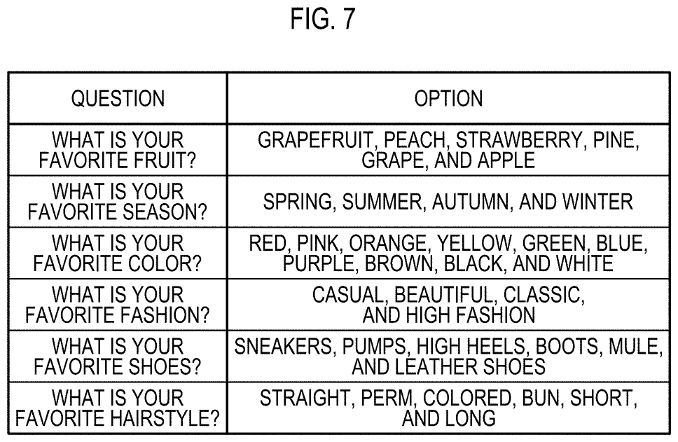

In the car sharing system 10 of the embodiment, in step S100 of the usage reservation processing routine shown in FIG. 3, the fragrance category selection screen shown in FIG. 4 is displayed, and the input of the fragrance category preferred by the user is received. However, instead of receiving the input of the fragrance category preferred by the user, a plurality of questions regarding the taste of the user and the options of answers regarding the questions may be displayed on the display 72 of the portable terminal device 70, the user's answers may be received, and the user preference information UP may be set based on a combination of the received answers. FIG. 7 is an explanatory diagram showing examples of the questions regarding the taste of the user and options of answers regarding the questions. Examples of the questions include “what is your favorite fruit?” or “what is your favorite season?” as shown in FIG. 7. Examples of the options include “grapefruit”, “peach”, “strawberry”, “pine”, “grape”, and “apple” for the question “what is your favorite fruit?”. Examples of the options include “spring”, “summer”, “autumn”, and “winter” for the question “what is your favorite season?”. From the combination of the answers, the fragrance FKup preferred by the user need only be set. For example, in a case where the user selects “grapefruit” for the question “what is your favorite fruit?”, “autumn” for the question “what is your favorite season?”, “blue” for the question “what is your favorite color?”, “high fashion” for the question “what is your favorite fashion?”, “high heels” for the question “what is your favorite shoes?”, and “long hair” for the question “what is your favorite hairstyle?”, determination is made that the user prefers a calm fragrance such as chypre, and the calm fragrance among the fragrances Fr1 to Fr6 that can be generated from the scent cartridges 34a to 34f need only be set as the fragrance FKup.

In the car sharing system 10 of the embodiment, in step S100 of the usage reservation processing routine shown in FIG. 3, the fragrance category selection screen shown in FIG. 4 is displayed, and the input of the fragrance category preferred by the user is received. However, a configuration may be adopted in which the usage reservation processing routine of FIG. 3 is not executed, and the input of the taste-related information related to the taste of the user is not received. In this case, in step S200 of the information transmission processing routine in FIG. 5, the user preference information UP set when the same user uses the car sharing system 10 before (previous information UPpre) may be searched based on the user identification number Pid included in the reservation request information when the usage of the vehicle 30 is reserved, and the searched previous information UPpre may be set as the user preference information UP. Also, the relationship between gender, age, occupation, and favorite music of the user and the fragrance preferred by the user may be stored in the storage device 22 in advance, the gender, age, occupation, and favorite music of the user may be derived from the user identification number Pid included in the reservation request information, and the fragrance preferred by the user may be derived and set as the user preference information UP based on the relationship between the derived information, the gender, age, occupation, and favorite music of the user, and the fragrance preferred by the user stored in the storage device 22. Also, the fragrance preferred by the user may be derived and set as the user preference information UP based on the determination on whether the time zone (morning or night) when the usage of the vehicle 30 is reserved from the usage start date and time ST included in the reservation request information or the return date and time or the vehicle usage time is a short tine less than a threshold tref (for example, 30 minutes, 1 hour, and 1 hour and half).

In the car sharing system 10 of the embodiment, the air conditioner ECU 40 that receives the target scent kind FK* and the target scent level FL* transmitted in step S350 of the prior fragrance release processing routine shown in FIG. 6 controls the opening and closing motors 38a to 38f such that the opening and closing door of the cartridge (corresponding cartridge) corresponding to the target scent kind FK* among the opening and closing doors 36a to 36f of the scent cartridges 34a to 34f is solely opened, and controls the air conditioner 31 and the fragrance generating blower 39 of the fragrance generator 32 such that the scent level FL in the vehicle cabin is the target scent level FL*. However, in addition to such control, the air conditioner 31 may be controlled such that the temperature and humidity in the vehicle cabin Cab is within a predetermined temperature range Rt (for example, 17° C. to 26° C.) that the user feels comfortable and within a predetermined humidity range Rh (for example, 25% to 75%). The predetermined temperature range Rt and the predetermined humidity range Rh may be changed depending on the area where the vehicle 30 is used and a usage season. For example, in a case where the vehicle 30 is used in Japan, when the usage season is May to October, the predetermined temperature range Rt may be set to 25° C. to 28° C., and the predetermined humidity range Rh may be 55% to 65%, when the usage season is November to April, the predetermined temperature range Rt may be set to 18° C. to 22° C., and the predetermined humidity range Rh may be 45% to 60%.

In the car sharing system 10 of the embodiment, the user preference information UP includes the fragrance FKup preferred by the user, and the fragrance level FLup that the user feels comfortable. However, the user preference information UP may include solely the fragrance FKup.

In the car sharing system 10 of the embodiment, the computer 21 of the management center 20 acquires the user preference information UP and the usage start date and time ST, the air conditioner ECU 40 of the vehicle 30 and the vehicle ECU 50 cause the fragrance generator 32 to generate the fragrance preferred by the user in the vehicle cabin Cab based on the user preference information UP before the usage start date and time ST. However, the computer 21 of the management center 20 may acquire the user preference information UP and the usage start date and time ST, and transmit fragrance generating instruction signals such that the fragrance generator 32 generates the fragrance preferred by the user in the vehicle cabin Cab based on the user preference information UP before the usage start date and time ST, and the air conditioner ECU 40 of the vehicle 30 and the vehicle ECU 50 may cause the fragrance generator 32 to generate the fragrance preferred by the user based on the user preference information UP in response to the reception of the fragrance generating instruction signals. Further, the acquisition of the user preference information UP and the usage start date and time ST may be performed by the portable terminal device 70. Further, the air conditioner ECU 40 of the vehicle 30 and the vehicle ECU 50 may acquire the user preference information UP and the usage start date and time ST, and cause the fragrance generator 32 to generate the fragrance preferred by the user in the vehicle cabin Cab based on the user preference information UP before the usage start date and time ST.

In the embodiment, a case where the car sharing system 10 according to the disclosure is applied is exemplified. However, the disclosure may be applied to another vehicle sharing system in which a plurality of users shares the same vehicle, such as a rental car system.

The correspondence between the main elements of the embodiment and the main elements of the disclosure described in summary of the disclosure will be described. In the embodiment, the fragrance generator 32 corresponds to the “fragrance generator”, the vehicle 30 corresponds to the “vehicle”, the computer 21 of the management center 20 corresponds to the “acquiring unit”, and the air conditioner ECU 40 and the vehicle ECU 50 of the vehicle 30 correspond to the “controller”.

The correspondence between the main elements of the embodiment and the main elements of the disclosure described in summary of the disclosure is a specific example of the embodiment for carrying out the disclosure described in summary of the disclosure, and does not limit the elements of the disclosure described in summary of the disclosure. That is, the interpretation of the disclosure described in summary of the disclosure should be made based on the description in the summary of the disclosure, the embodiment is solely a specific example of the disclosure described in summary of the disclosure.

Although the embodiment for carrying out the disclosure has been described, the disclosure is not limited to the embodiment, and it is needless to say that various embodiments are used without departing from the gist of the disclosure.

The disclosure can be used in the manufacturing industry of a control device for a vehicle sharing system.

What is claimed is:

1. A control device for a vehicle sharing system in which a plurality of persons shares a vehicle having a fragrance generator configured to generate a fragrance in a vehicle cabin, the device comprising:
an acquiring unit configured to acquire user preference information as information relating to a fragrance preferred by a user who starts using the vehicle, and a usage start date and time when the user starts using the vehicle; and
a controller configured to cause the fragrance generator to generate the fragrance preferred by the user in the vehicle cabin based on the user preference information before the usage start date and time.

2. The control device according to claim 1, further comprising an input receiver configured to receive input of taste-related information relating to taste of the user,
wherein the acquiring unit is configured to acquire the user preference information by using the input taste-related information.

3. The control device according to claim 2, wherein the taste-related information is a category of the fragrance preferred by the user.

4. The control device according to claim 2, further comprising a display unit configured to display a plurality of questions regarding the taste of the user,
wherein the input receiver is configured to receive input of answers of the user regarding the questions as the input of the taste-related information.

5. The control device according to claim 1, wherein:
the vehicle includes an air conditioner that performs air conditioning;
the user preference information includes the fragrance preferred by the user, and an intensity of the fragrance that the user feels comfortable; and
the controller is configured to control the fragrance generator and the air conditioner such that the fragrance preferred by the user is generated in the vehicle cabin, and an intensity of the fragrance in the vehicle cabin becomes the intensity of the fragrance that the user feels comfortable based on the user preference information before the usage start date and time.

6. The control device according to claim 1, wherein:
the vehicle sharing system includes the vehicle, and a management server configured to manage the vehicle;
the acquiring unit is mounted on the management server; and
the controller is mounted on the vehicle.

7. The control device according to claim 2, wherein:
the vehicle sharing system includes the vehicle, a management server configured to manage the vehicle, and a terminal device used by the user;
the input receiver is mounted on the terminal device;
the acquiring unit is mounted on the management server; and
the controller is mounted on the vehicle.

8. The control device according to claim 4, wherein:
the vehicle sharing system includes the vehicle, a management server configured to manage the vehicle, and a terminal device used by the user;
the input receiver and the display unit are mounted on the terminal device;
the acquiring unit is mounted on the management server; and
the controller is mounted on the vehicle.
